(19) United States
(12) Patent Application Publication
(10) Pub. No.: US 2018/0335205 A1
(43) Pub. Date: Nov. 22, 2018

(54) PRESSURIZED FLUIDIZED BED COMBUSTOR WITH FUEL CELL CO2 CAPTURE

(71) Applicant: Gas Technology Institute, Des Plaines, IL (US)

(72) Inventor: William W. Follett, Agoura Hills, CA (US)

(73) Assignee: Gas Technology Institute, Des Plaines, IL (US)

(21) Appl. No.: 15/980,383

(22) Filed: May 15, 2018

Related U.S. Application Data
(60) Provisional application No. 62/507,398, filed on May 17, 2017.

(51) Int. Cl. F23C 10/16; H01M 8/14; H01M 8/0612; H01M 8/0662; F23C 10/00; F23J 15/02

(52) U.S. Cl. CPC F23C 10/16; H01M 8/145; H01M 8/0643; H01M 2008/147; H01M 8/0687; F23C 10/002; F23J 15/025; H01M 8/0675

(57) ABSTRACT

Systems and methods for generating electrical power combine pressurized fluidized bed combustors (PFBC) and molten carbonate fuel cells (MCFC) to provide a low cost solution for electricity generation with CO₂ capture. A solid fuel is introduced fuel into a pressurized fluidized bed combustor to produce steam, a first quantity of electrical power, and a flue gas including CO₂. Air, natural gas, at least a portion of the steam and at least a portion of the flue gas including CO₂ are introduced to a molten carbonate fuel cell to produce a second quantity of electrical power and an output stream comprising primarily CO₂. The pressurized fluidized bed combustor can desirably be air-fired and the solid fuel introduced there into can desirably be in a finely pulverized form.

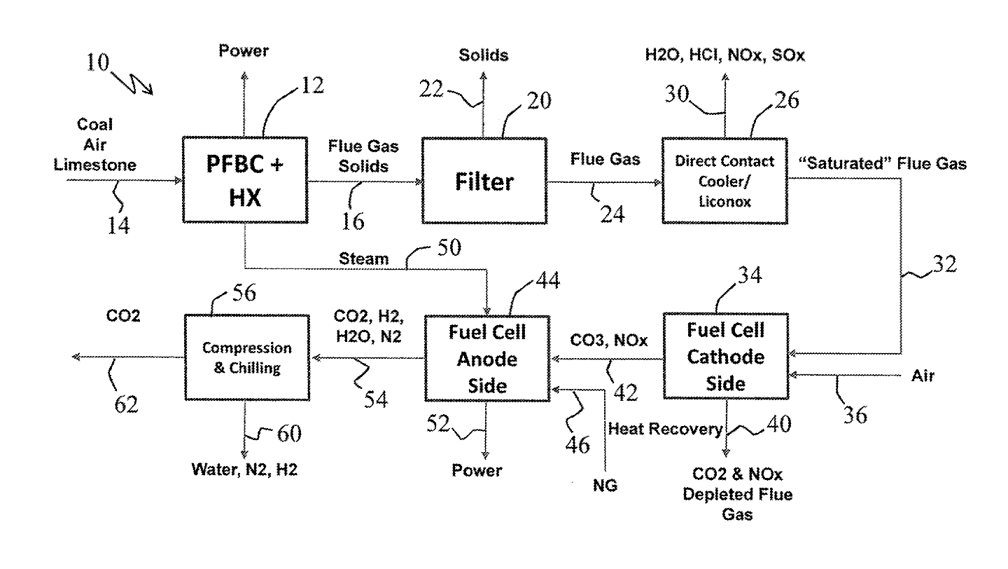

### CROSS REFERENCE TO RELATED APPLICATION(S)

This application claims the benefit of U.S. Provisional patent application Ser. No. 62/1507,398, filed on 17 May 2017. The co-pending Provisional Application is hereby incorporated by reference herein in its entirety and is made a part hereof, including but not limited to those portions which specifically appear hereinafter.

The subject matter of this application is also related to prior U.S. Provisional Patent Application Ser. No. 61/184,367, filed on 5 Jun. 2009; prior U.S. Provisional Patent Application Ser. No. 61/184,384, filed on 5 Jun. 2009; prior U.S. Provisional Patent Application Ser. No. 61/184,382, filed on 5 Jun. 2009; prior U.S. Provisional Patent Application Ser. No. 61/184,383, filed on 5 Jun. 2009; prior U.S. patent application Ser. No. 12/794,218, filed on 4 Jun. 2010, now U.S. Pat. No. 9,567,876, issued 14 Feb. 2017; and prior U.S. patent application Ser. No. 15/085,113, filed on 30 Mar. 2016, now U.S. Pat. No. 9,803,512, issued 31 Oct. 2017. The disclosures of U.S. Pat. No. 9,567,876 and U.S. Pat. No. 9,803,512 are also incorporated by reference herein in their entirety and are made a part hereof, including but not limited to those portions which specifically appear hereinafter.

### BACKGROUND OF THE INVENTION

### Field of the Invention

This invention relates generally to power generation and, more particularly, to the generation of electrical power with solid fuel and with capture of CO₂.

### Description of Related Art

Above-identified U.S. Pat. No. 9,567,876 and U.S. Pat. No. 9,803,512 identify and describe pressurized fluidized bed combustors (PFBC) that have been developed to provide a low cost combustor solution such as for use in or for electricity generation.

There is a need for electricity power generation with solid fuel and CO₂ capture that minimizes the impact on cost of electricity (COE). The currently employed state of the art CO₂ capture technology is post combustion capture systems that use amine solvents. According to DOE analysis, these systems increase the cost of electricity by roughly 75% compared to a coal power plant with no CO₂ capture.

### SUMMARY OF THE INVENTION

A general object of the invention is to provide improved power generation.

A more specific objective of the invention is to overcome one or more of the problems described above.

The subject invention development combines pressurized fluidized bed combustors (PFBC) and molten carbonate fuel cells (MCFC), to provide a low cost solution for electricity generation with CO₂ capture. The pressurized fluidized bed combustors provide a low cost combustor solution, while the molten carbonate fuel cells provide a CO₂ separation capability that generates electricity rather than creating a parasitic load. The combination of reduced capital cost due, associated with or resulting from the inclusion and use of pressurized fluidized bed combustors and reduced operational cost due, associated with or resulting from the inclusion and use of molten carbonate fuel cells significantly improves the state of the art for electricity generation with CO₂ capture.

One aspect of the subject invention development relates to a method for generating electrical power. In accordance with one embodiment a method for generating electrical power involves introducing a solid fuel into a pressurized fluidized bed combustor to produce steam, a first quantity of electrical power, and a flue gas including CO₂. The method further involves introducing air, natural gas, at least a portion of the steam and at least a portion of the flue gas including CO₂ to a molten carbonate fuel cell to produce a second quantity of electrical power and an output stream comprising primarily CO₂.

Another aspect of the subject invention development relates to a system for generating electrical power. In accordance with one embodiment a system for generating electrical power includes a pressurized fluidized bed combustor to process a solid fuel to produce steam, a first quantity of electrical power, and a flue gas including CO₂ and a molten carbonate fuel cell wherein air, natural gas, the flue gas including CO₂ and the steam produced by the pressurized fluidized bed combustor are introduced to produce a second quantity of electrical power and an output stream of primarily CO₂.

As used herein, references to the output stream of the molten carbonate fuel as “primarily CO₂” are to be understood to refer to such an output stream that contains CO₂ in a relative amount of at least 90% or more, preferably at least 95% or more, and in some cases at least 99.9% or more, where these percentages are volume percentages.

Other objects and advantages will be apparent to those skilled in the art from the following detailed description taken in conjunction with the appended claims and drawing.

### BRIEF DESCRIPTION OF THE DRAWING

Objects and features of this invention will be better understood from the following description taken in conjunction with the drawing which illustrates a simplified schematic of a processing system or arrangement in accordance with one embodiment of the present development.

### DETAILED DESCRIPTION

Combining pressurized fluidized bed combustors (PFBC) with molten carbonate fuel cells (MCFC), as detailed below, desirably provides a low cost solution for electricity generation with CO₂ capture.

More particularly, the incorporation and use of pressurized fluidized bed combustors (PFBC) as herein proposed allows combustion of solid fuel, such as including without unnecessary limitation coal, petcoke, biomass, and the like or combinations thereof, for example, in a compact low cost combustor. In accordance with one preferred embodiment, the PFBC is roughly ⅓ the size of a traditional coal boiler and less than ½ the cost. Although oxygen-fired pressurized fluidized bed combustors such as are currently under development are envisioned for use in the practice of the subject development and are encompassed herein, the subject development is further described below making specific reference to an embodiment that employs air-fired pressurized fluidized bed combustors as benefits attendant the inclusion and use of a fuel cell such as for CO₂ separation may be more apparent with such an air-fired operation.

Those skilled in the art and guided by the teachings herein provided will understand and appreciate that the employment and use of air-fired pressurized fluidized bed combustors can desirably serve to eliminate need of and the capital costs resulting from or associated with an air separation unit (ASU), which produces the oxygen, and the large parasitic load associated with it. For example, air separation units can, in particular embodiments, contribute roughly 25% of the cost of an oxygen-fired pressurized fluidized bed combustor power plant.

In accordance with one preferred embodiment, the pressurized fluidized bed combustor works by using finely pulverized solid fuel to achieve rapid combustion and small combustor size. A finely pulverized sorbent, if desired, can also be fed into the pressurized fluidized bed combustor such as to absorb sulfur. In one preferred practice of the invention, both the fuel and the sorbent are fed into the bottom of the combustor and elutriated through, with ash and sorbent coming out of the top of the combustor and captured in a filter. While fast reaction rates reduce the combustor size, the heat is desirably removed correspondingly as fast to avoid or prevent overheating of the coal and ash, which could lead to ash agglomeration and fouling of the combustor. To remove heat and generate steam, in one embodiment, boiler tubes are inserted into the combustor. However, such boiler tubes may not serve to remove heat quickly enough from the hot combustor gas. As a result, in one embodiment, a fluidized bed of small solid particles is added. This can desirably serve to increase the heat transfer to the boiler tubes such as by a factor of three or more. Pressurization, combined with the fluidized bed, increases heat transfer by a factor of five or more, allowing sufficient heat removal. The result is a compact low cost combustor.

Further, as detailed below and in accordance with one preferred embodiment of the invention, at least a portion of the steam produced or generated in or by the pressurized fluidized bed combustor is diverted or and provided to the molten carbonate fuel cell as input. This steam can be desirably utilized for internal reforming of the natural gas or biogas feedstock in the fuel cell. Such steam production, generation and use eliminates the need for a separate steam generator.

After the solid fuel is burned in the pressurized fluidized bed combustor, the flue gas is processed such as to remove solids, water, and excess SOx as well as possibly other trace impurities that may cause issues for the fuel cell. The flue gas, which is primarily N₂ and CO₂ with trace NOₓ, is then fed to the fuel cell.

The molten carbonate fuel cell receives the following input streams: 1) flue gas, 2) air, 3) natural gas, and 4) steam from the pressurized fluidized bed combustor. The output of the fuel cell is or includes: 1) electrical power, 2) the flue gas stream that is now primarily N₂, since it has been stripped of CO₂ and NOₓ, and 3) a stream that is primarily CO₂, with H₂, N₂ (from the NOₓ), and water. The last stream, that is primarily CO₂, can, if desired, undergo additional purification steps such to remove sufficient H₂, N₂ and water to achieve CO₂ purity specifications for sequestration or enhanced oil recovery.

The molten carbonate fuel cell desirably serves to produce power while simultaneously capturing CO₂. The molten carbonate fuel cell creates CO₃⁻ at the cathode by combining CO₂ in the flue gas stream with oxygen from the air stream and electrons from the electron stream. CO₃⁻ and NOx pass through the fuel cell. The remainder of the flue gas (primarily N₂) can desirably be released to the atmosphere.

Natural gas and steam are introduced into the fuel cell and undergo a reforming process, using heat from the fuel cell, to produce H₂ and CO₂. At the fuel cell anode, the H₂/CO₂ stream mixes with the CO₃⁻/NOₓ stream. H₂ combines with CO₃⁻ to produce water (H₂O), CO₂ and electricity (2 electrons for each CO₃⁻ ion). The NOx will combine with H₂ to produce N₂ and H₂O. As a result, the output stream is primarily CO₂ with impurities of water, H₂ and N₂. This CO₂ stream can then be dried, and the trace H₂ and N₂ can be removed to achieve CO₂ purity specifications, e.g., specifications for sequestration or enhanced oil recovery.

Preliminary technoeconomic analysis of the subject development proposed invention predicts that the COE penalty is only 10-15%. This is a significant improvement as compared to other technology under development. Moreover, while such cost of electricity calculations assume no economic benefit from selling the purified CO₂ stream, the sale of the CO₂ could put the COE on par with a coal plant without CO₂ capture.

Thus, a primary advantage in accordance with one aspect of the subject development is the low cost of electricity for a solid fuel power plant with carbon capture as compared to other technologies that are in the market or under development.

One of the synergies in accordance with one aspect of the subject development is the need for the fuel cell to have flue gas that is nearly sulfur-free, and the ability of the PFBC to deliver this flue gas cost effectively by capturing 95% of the sulfur in the combustor.

One of the factors that reduces COE for the PFBC-FC is the synergy between the PFBC and fuel cell concepts. The fuel cell generally cannot tolerate more than 1 PPM of sulfur in the flue gas. Since sulfur is naturally occurring in coal, expensive equipment must typically be provided in or with systems utilizing such coal to remove the sulfur from the flue gas prior to the fuel cell. In a standard plant, this is commonly provided by a Flue Gas Desulfurization (FGD) unit, which is expensive. In the subject development, the PFBC takes an alternative approach to sulfur removal. In one embodiment, it uses pulverized dolomite both as bed material in the fluidized bed, and as small particles injected with the fuel, to capture up to 95% of the sulfur in the combustor itself. As a result, if desired, a lower cost gas polishing unit can be used to clean up the remaining trace sulfur in the flue gas. Cost analysis indicates that this approach results in significant savings in required flue gas cleanup equipment costs and significant reductions in the parasitic load associated with the process and equipment.

Reference is no made to the FIGURE which illustrates a simplified schematic of a processing system or arrangement, generally designated by the reference numeral 10, such as described above and in accordance with one embodiment of the present development.

For example, the system 10 includes a pressurized fluidized bed combustor (PFBC) such as with or without a heat exchanger, generally designated 12. The PFBC 12 is air-fired and is fed, as signified by the stream 14, coal (or other desired solid fuel, preferably in a finely pulverized or divided form), air and limestone (or other desired sorbent, preferably in a finely pulverized or divided form).

After the solid fuel is burned in the pressurized fluidized bed combustor 12, the flue gas and solids are passed (as signified by the stream 16) to a separation processing stage 20, such as a filter and processed such as to remove solids, signified by the stream 22. A stream 24 from the separation processing stage 20 and largely composed of flue gas is introduced into a flue gas further processing stage 26 such as to remove water, HCl, NOx, SOx as well as possibly other trace impurities that may cause issues for the fuel cell, such removed materials being signified by the stream 30. The resulting “saturated” flue gas, which is primarily N₂ and CO₂, is then fed, as signified by the stream 32 to the fuel cell, specifically the fuel cell cathode side as signified by the box 34. The fuel cell cathode side 34 also receives an input stream 36 of air.

A stream 40, such as composed of CO₂, NOx and depleted flue gas is removed from the fuel cell cathode side 34. If desired, such materials may be subjected to appropriate heat recovery processing, such as is known in the art.

A stream 42, such as composed primarily of CO₃ and NOx, is passed from the fuel cell cathode side 34 to the fuel cell anode side 44.

The molten carbonate fuel cell, and more particularly the fuel cell anode side 44 also receives input streams of natural gas (stream 46) and steam (stream 50) from the pressurized fluidized bed combustor 12. The output of the fuel cell is or includes: electrical power (stream 52) and a stream 54 that is primarily CO₂, with H₂, N₂ (from the NOₓ), and water. The stream 54, that is primarily CO₂, can, if desired, undergo additional processing steps such as signified by the box 56 and such as may for example take the form of compression and chilling, such as to facilitate subsequent transport or conveyance and remove sufficient H₂, N₂ and water (signified by the stream 60) to achieve a stream 62 of CO₂ such as may satisfy purity specifications for use in one or more of sequestration, enhanced oil recovery, chemical production, as an industrial gas and food product incorporation such as in or for carbonated beverages, for example.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed includes:

1. A method for generating electrical power, said method comprising:
introducing a solid fuel into a pressurized fluidized bed combustor to produce steam, a first quantity of electrical power, and a flue gas comprising CO₂ and N₂; and
introducing air, natural gas, at least a portion of the steam and at least a portion of the flue gas comprising CO₂ to a molten carbonate fuel cell to produce a second quantity of electrical power and an output stream comprising primarily CO₂.

2. The method of claim 1 wherein the pressurized fluidized bed combustor is air-fired.

3. The method of claim 1 wherein the solid fuel introduced into the pressurized fluidized bed combustor is in a finely pulverized form.

4. The method of claim 1 wherein solid fuel is selected from the group consisting of coal, petcoke, biomass and combinations thereof.

5. The method of claim 1 comprising:
additionally introducing a finely pulverized sorbent into the pressurized fluidized bed combustor to absorb sulfur.

6. The method of claim 1 additionally comprising processing the output stream comprising primarily CO₂ to achieve CO₂ purity specifications for at least one subsequent use selected from the group consisting of sequestration, enhanced oil recovery, chemical production, as an industrial gas and incorporation in a food product.

7. The method of claim 1 wherein the pressurized fluidized bed combustor produces a product stream comprising flue gas and combustion solids, the method additionally comprising the steps of:
filtering the product stream to separate the combustion solids from the flue gas and
polish processing the separated flue gas to remove impurities and form a saturated flue gas consisting essentially of N₂ and CO₂.

8. The method of claim 7 wherein the molten carbonate fuel cell includes a fuel cell cathode and a fuel cell anode, said method additionally comprising:
introducing the saturated flue gas and the air into the fuel cell cathode to produce a first product stream comprising CO₃ and NOₓ and a second product stream comprising flue gas with both CO₂ and NOx depleted; and
introducing the first product stream, the natural gas and the at least a portion of the steam produced by the pressurized fluidized bed combustor into the fuel cell anode to produce the second quantity of electrical power and the output stream comprising CO₂.

9. The method of claim 8 wherein the output stream additionally comprises non-CO₂ impurities selected from the group consisting of H₂, H₂O, N₂ and combinations thereof, said method additionally comprises:
purifying the output stream to remove non-CO₂ impurities.

10. The method of claim 9 wherein said purifying comprises compression and chilling to remove non-CO₂ impurities.

11. A system for generating electrical power, said system comprising:
a pressurized fluidized bed combustor to process a solid fuel to produce steam, a first quantity of electrical power, and a flue gas comprising CO₂ and N₂; and
a molten carbonate fuel cell wherein air, natural gas, the flue gas comprising CO₂ and the steam produced by the pressurized fluidized bed combustor are introduced to produce a second quantity of electrical power and an output stream comprising primarily CO₂.

12. The system of claim 11 wherein the pressurized fluidized bed combustor is air-fired.

13. The system of claim 11 wherein the solid fuel introduced into the pressurized fluidized bed combustor is in a finely pulverized form.

14. The system of claim 11 wherein solid fuel is selected from the group consisting of coal, petcoke, biomass and combinations thereof.

15. The system of claim 11 wherein a finely pulverized sorbent introduced into the pressurized fluidized bed combustor serves to absorb sulfur.

16. The system of claim 11 additionally comprising a processing assembly to process the output stream comprising primarily CO₂ to achieve CO₂ purity specifications for at least one subsequent use selected from the group consisting of sequestration, enhanced oil recovery, chemical production, as an industrial gas and incorporation in a food product.

17. The system of claim 11 wherein the pressurized fluidized bed combustor produces a product stream comprising flue gas and combustion solids, the system additionally comprising:
a separator to process the product stream to separate the combustion solids from the flue gas and
a polishing unit to polish process the separated flue gas to remove impurities and form a saturated flue gas consisting essentially of N₂ and CO₂

18. The system of claim 17 wherein the molten carbonate fuel cell comprises:
a fuel cell cathode wherein the saturated flue gas and the air are introduced to produce a first product stream comprising CO₃ and NOₓ and a second product stream comprising flue gas with both CO₂ and NOx depleted; and
a fuel cell anode wherein first product stream, the natural gas and the steam produced by the pressurized fluidized bed combustor are introduced to produce the second quantity of electrical power and the output stream comprising CO₂.

19. The system of claim 18 wherein the output stream additionally comprises non-CO₂ impurities selected from the group consisting of H₂, H₂O, N₂ and combinations thereof, said system additionally comprises:
a purifier to remove non-CO₂ impurities from the output stream.

20. The system of claim 19 wherein said purifier comprises a compressor and a chiller to remove non-CO₂ impurities.
